(19) United States
(12) Patent Application Publication
(10) Pub. No.: US 2007/0196189 A1
(43) Pub. Date: Aug. 23, 2007

(54) BALL SCREW DEVICE AND METHOD OF MANUFACTURING THE SAME

(75) Inventor: Sentaro SUGITA, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYODA KOKI KABUSHIKI KAISHA, Kariya-shi (JP)

(21) Appl. No.: 11/672,424

(22) Filed: Feb. 7, 2007

Related U.S. Application Data
(62) Division of application No. 10/603,858, filed on Jun. 26, 2003, now abandoned.

(30) Foreign Application Priority Data
Jun. 26, 2002 (JP) 2002-186036

(51) Int. Cl. B23G 1/32; F16H 1/24

(52) U.S. Cl. 409/65; 74/424.87

(57) ABSTRACT

A ball screw mechanism comprises a nut, a screw shaft, plural balls and a deflector. The balls are arranged between a first thread groove which is formed on an inner surface of the nut and a second thread groove which is formed on an outer surface of the screw shaft. The deflector comprises a deflector piece which defines a top plate of a ball-return path and a guide member which defines sidewalls of the ball-return path. The ball-return path returns the balls so as to circulate endlessly. As a manufacturing method of the ball screw device, the deflector piece is attached to the nut first. Next, the first thread groove is ground together with an inner surface of the deflector piece. After that, the guide member is attached to the nut. At last, the balls and the screw shaft are assembled to the nut.

### INCORPORATION BY REFERENCE

This application is a divisional of and is based upon and claims the benefit of priority under 35 U.S.C. §120 for U.S. Ser. No. 10/603,858, filed Jun. 26, 2003, and claims the benefit of priority under 35 U.S.C. § 119 from Japanese Patent Application No. 2002-186036, filed Jun. 26, 2002, the entire contents of each which are incorporated herein by reference.

### BACKGROUND OF THE INVENTION

1. Field of the Invention

This invention relates to a ball screw device, more particularly to a deflector-type ball screw mechanism, and method of manufacturing such ball screw device.

2. Discussion of the background

As one of ball screw devices that transforms rotational movement into linear movement and linear movement into rotational movement, a deflector-type ball screw device is known by Japanese Laid-Open Patent Application No. 11-270647, for example. Such conventional deflector-type ball screw device comprises a screw shaft that a thread groove is formed on an outer surface thereof, a nut that a thread groove is formed on an inner surface thereof, plural balls which exist between the thread grooves, and plural deflectors. A ball-roll path that the balls roll therein is provided by making the thread groove of the screw shaft be opposite to the thread groove of the nut. The deflector is attached into a through hole that is formed on the nut so as to penetrate it in radial direction. A concavity is formed on an inner surface of the deflector, so a ball-return path is provided by the deflector being attached. The balls can climb over a ridge of the thread groove of the screw shaft by going through the ball-return path. Therefore, the balls are circulated endlessly into the ball-roll path and the ball-return path. Since plural deflectors are generally used, ball-circulation paths, which mean pair of the ball-roll path and the ball-return path, of the same number as the deflector are provided respectively.

According to such ball screw device, when the nut is rotated, rotational force of the nut is smoothly transformed into force that moves the screw shaft in its axial direction by the balls being circulated endlessly through the ball-circulation path with receiving load. As a result, the screw shaft is moved in its axial direction. Similarly, when the screw shaft is rotated, the nut is moved in its axial direction, and when one of the screw shaft and the nut is moved in its axial direction, the other is rotated.

At conventional processes for manufacturing the deflector-type ball screw device, the thread groove of the nut is ground before the deflector is attached to the nut. After that, the deflector, which the concavity has been formed on, is attached into the through hole of the nut. Therefore, a step and a gap easily occur at a seam portion between the thread groove of the nut and the concavity of the deflector. Such step and gap prevent that the balls move smoothly, and cause operation failure of the ball screw device. Or, in order to remove such step, an extra process that finishes the seam portion between the thread groove and the deflector by manual operation is needed.

### SUMMARY OF THE INVENTION

In view of the foregoing, it is an object of the present invention to provide improved ball screw device and an improved manufacturing method of a ball screw device. In order to achieve the above and other objects, a first aspect of the present invention provides a ball screw mechanism which comprises a nut, a screw shaft, a plural number of balls and a deflector. A first thread groove is formed on an inner surface of the nut. A second thread groove is formed on an outer surface of the screw shaft. The balls are arranged between the first thread groove and the second thread groove. The deflector is built into the nut to provide a ball-return path which returns the balls so as to circulate endlessly. The deflector comprises a deflector piece which defines a top plate of the ball-return path and a guide member which defines sidewalls of the ball-return path.

A second aspect of the present invention provides a manufacturing method of a ball screw device which comprises a nut, a screw shaft, a plural number of balls, and a deflector which comprises a deflector piece and a guide member. The manufacturing method comprises attaching the deflector piece to the nut, grinding an inner surface of the nut together with an inner surface of the deflector piece, attaching the guide member to the nut, and assembling the balls and the screw shaft to the nut.

A third aspect of the present invention provides a manufacturing method of a ball which comprises a nut, a screw shaft, a plural number of balls, and a deflector which comprises a deflector piece and a guide member. The manufacturing method comprises attaching the deflector piece to the nut, grinding an inner surface of the nut together with an inner surface of the deflector piece, detaching the deflector piece from the nut, assembling the balls and the screw shaft to the nut, and attaching the deflector piece and the guide member to the nut.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a cross-sectional view of a ball screw device according to an embodiment of the present invention;

FIG. 2 is a development of a nut and a deflector of the ball screw device;

FIG. 3 is a plane view of a deflector piece of the deflector seeing in a direction shown by arrow III in FIG. 2;

FIG. 4 is a cross-sectional view of the deflector piece along IV-IV in FIG. 3;

FIG. 5 is plane view of a guide member of the deflector seeing in a direction shown by arrow V in FIG. 2;

FIG. 6 is a cross-sectional view of the guide member taking along VI-VI in FIG. 5;

FIG. 7 is a cross-sectional view showing the deflector and the nut;

FIG. 8 is a fragmentary cross-sectional view showing the deflector piece attached on the nut;

FIG. 9 is a fragmentary cross-sectional view showing the guide member attached on the nut;

FIG. 10 is a schematic view showing a modification of the embodiment to fix a deflector to a nut.

### DESCRIPTION OF THE PREFERRED EMBODIMENT

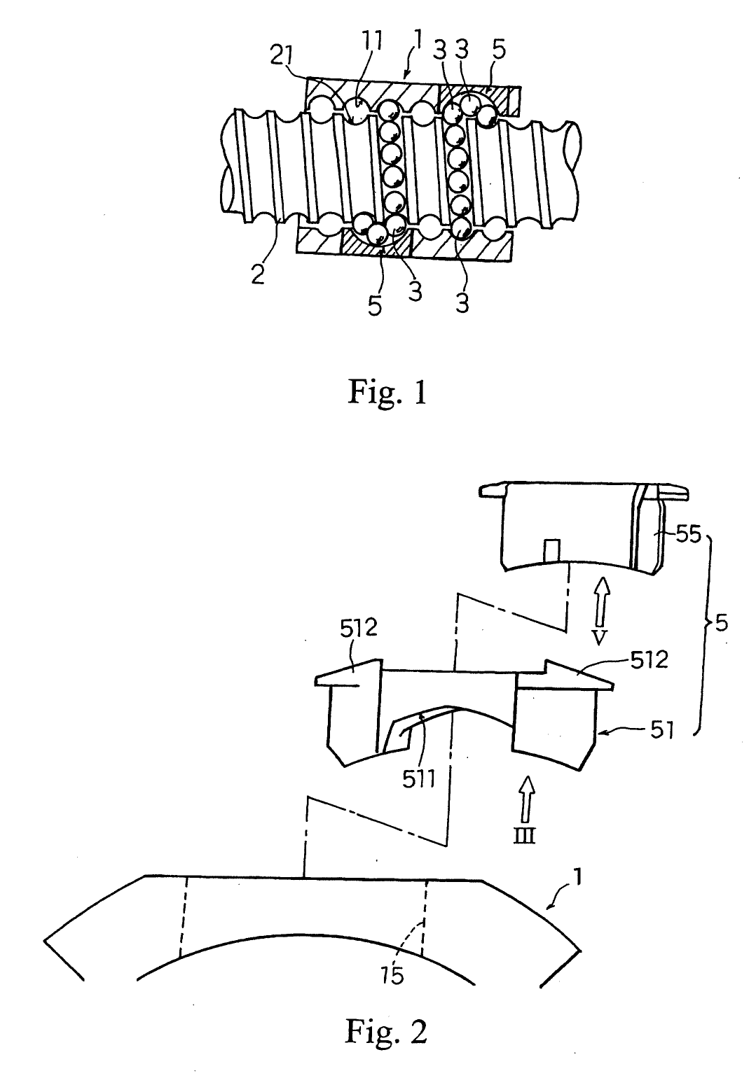

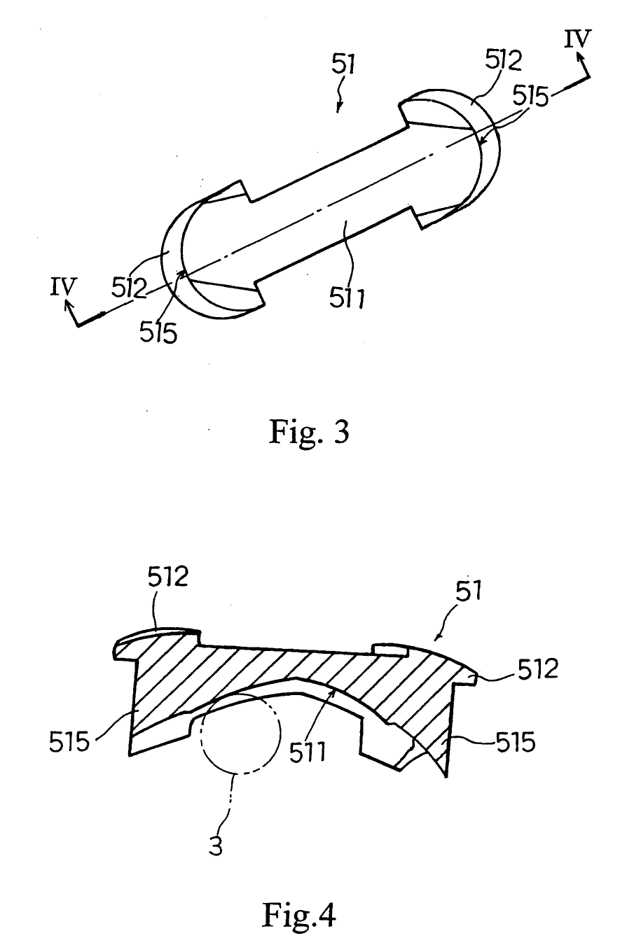

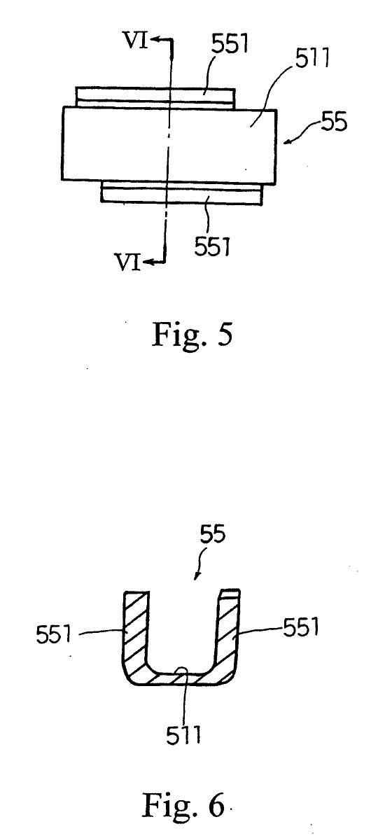

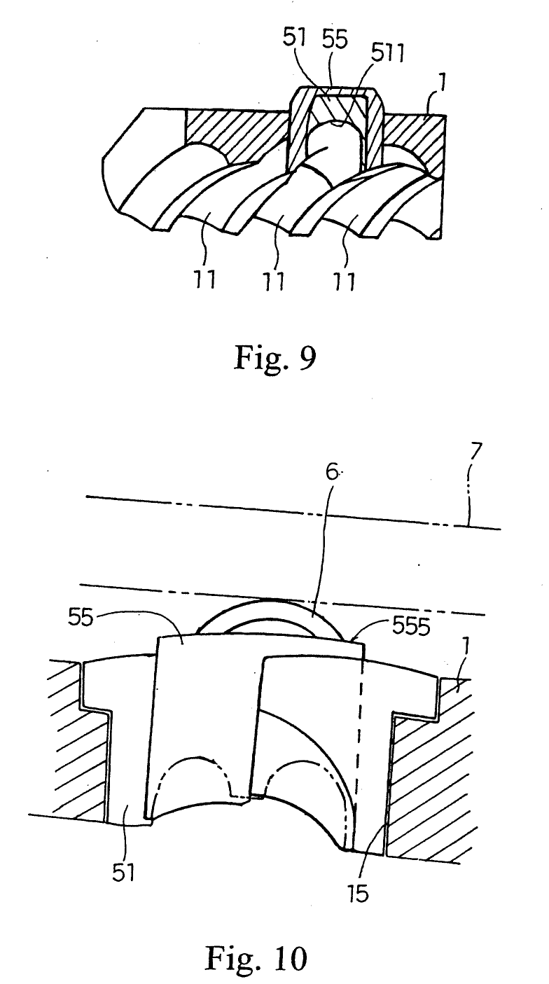

A ball screw device as an embodiment of the present invention will be described with reference to FIGS. 1-9. The ball screw device comprises a nut 1, a screw shaft 2 that is moved for the nut 1 relatively, plural balls 3 made of steel and plural deflectors 5 as shown by FIG. 1. A first thread groove 11 is formed on an inner surface of the nut 1. A second thread groove 21 is formed on an outer surface of the screw shaft 2. Since dimensions of both thread grooves 11, 21 are the same, a spiral ball-roll path is provided by opposing the thread grooves 11, 21 each other, in which the balls 3 exist and roll with receiving load. Each deflector 5 guides the balls 3 so as to climb over a ridge of the second thread groove 21 in order that the balls 3 endlessly circulate.

Each deflector 5 of the embodiment comprises two pieces that are a deflector piece 51 and a guide member 55. The deflector piece 51 is shaped like an arch as shown by FIG. 2 and FIG. 4. A concavity 511 is formed on an intermediate portion of the arch. Both prop portions 515 of the arch are fitted into a through hole 15 formed into the nut 1 so as to penetrate it in radial direction. A flange 512 is formed on each prop portion 515 in order to fix the deflector piece 51 to the nut 1. On the other hand, the guide member 55 is shaped so that its cross section is U-shape having both side portions 551 as shown by FIG. 2 and FIG. 6. A ball-return path is provided by the deflector piece 51 and the guide member 55 being fitted into the through hole 15 of the nut 1 so that both side portions 551 sandwich the intermediate portion of the deflector piece 51. That is, the concavity 511 defines a top plate of the ball-return path and, both side portions 551 of the guide member 55 define sidewalls of the ball-return path. Since the deflector piece 51 and the guide member 55 are attached to the nut 1 in a direction that crosses a leading direction of the thread grooves 11, 21, the balls 3 can climb over the ridge of the second thread groove 21 through the ball-return path. Therefore, the balls 3 circulate endlessly through the ball-roll path and the ball-return path according to relative movement between the nut 1 and the screw shaft 2. Although a couple of the deflectors 5 are shown by FIG. 1, more deflectors 5, for example four, are used and arranged at an equal interval in circumferential direction. That is, pairs of the ball-roll path and the ball-return path of the same number as the deflectors 5 are provided. In a case that the nut 1 is rotated, it is preferable that the deflectors 5 are arranged at the equal interval in circumferential direction, because the nut 1 is not unbalanced.

According to the aforementioned ball screw device, when the nut 1 is rotated by a motor (not shown), rotational force of the nut 1 is smoothly transformed into force that moves the screw shaft 2 in its axial direction by the balls 3 being circulated endlessly through the ball-roll path and the ball-return path with receiving load. As a result, the screw shaft 2 is moved in its axial direction. Similarly, when the screw shaft 2 is rotated, the nut 1 is moved in its axial direction, and when one of the nut 1 and the screw shaft 2 is moved in its axial direction, the other is rotated.

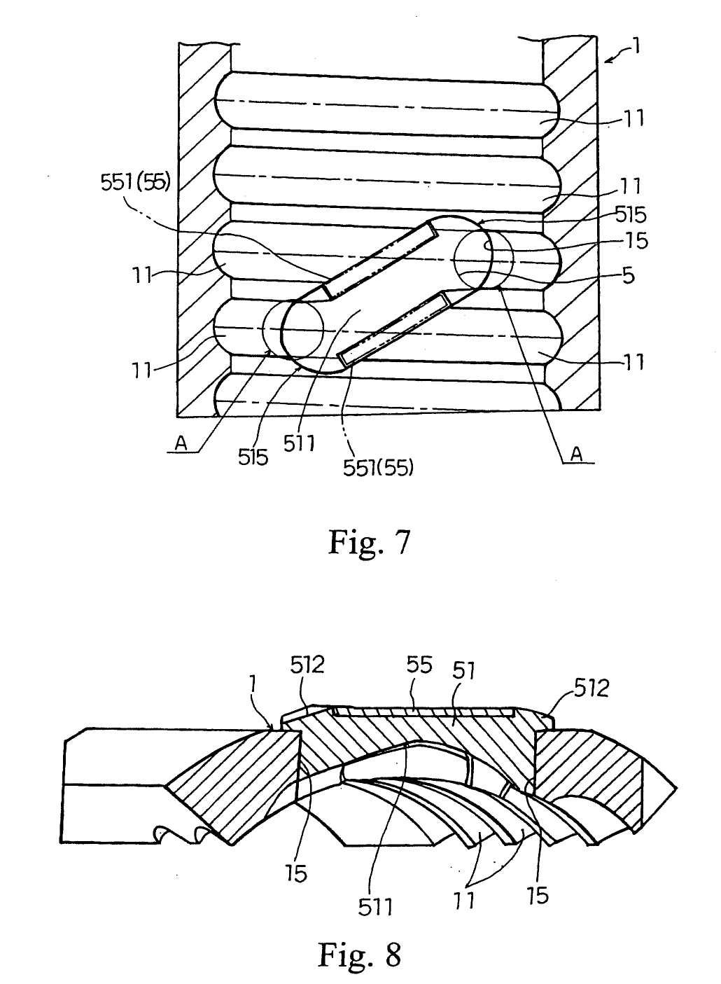

A manufacturing method of the above ball screw device will be described hereinafter. First, the deflector pieces 51 are attached to the nut 1 so that the prop portions 515 of each deflector piece 51 are inserted into the through hole 15 of the nut 1. The deflector pieces 51 are fixed to the nut 1 by the flanges 512 being caulked. Now, other fixing ways such as screws can be used for fixing the deflector pieces 151 in stead of the caulking. Next, the first thread groove 11 of the nut is ground by an internal thread grinding machine, for example. Then, a surface of the concavity 511 of each deflector piece 51 can be ground together with a surface of the first thread groove 11, because the guide members 55 are not attached to the nut 1 yet and the side portions 551 of each guide member 55, which interrupts the first thread groove 11, do not exist. Therefore, even if there is a step at seams between the first thread groove 11 and each deflector piece 51 (shown by A in FIG. 7), the step is removed by the grinding. After that, the guide members 55 are attached into the through holes 15 of the nut 1 so that the deflector piece 51 is sandwiched by the U-shaped guide member 55 (see FIG. 2). The attached guide members 55 are fixed to the deflector pieces 51 by caulking. Similar to fixing the deflector piece 5 1, other fixing ways such as screws can be used for fixing the guide members 55. At the end, the balls 3 are assembled to the nut 1 together with the screw shaft 2 so that the balls 3 are filled in each ball-roll path and each ball-return path with appropriate clearances. Then, the balls 3 and the screw shaft 2 can be assembled together by using a well-known ball insertion tool. However, it is possible that the balls 3 and the screw shaft 2 are also assembled without using such ball insertion tool. That is, the balls 3 are inserted through the through hole 15 at this way. To adopt this way, it is needed that the deflector piece 51 is fixed to the nut 1 temporarily and is detached from the nut 1 once after the grinding process. After that, the screw shaft 2 is inserted into the nut 1 and the balls 3 are inserted through the through hole 15 and, the deflector piece 51 and the guide member 55 are fixed to the nut 1 permanently. Further, not only the balls 3 but also separators can be inserted into the ball-roll path and the ball-return path. That is, the separator is arranged between the balls 3 respectively. The separators keep appropriate clearances between the balls 3 and help the balls 3 smoothly roll.

According to the aforementioned manufacturing method of the ball screw device, the balls 3 can be rolled smoothly, because the concavities 511 of the deflector pieces 51 are ground together with the first thread groove 11 and there is no step at the seam between the first thread groove 11 and each deflector piece 51.

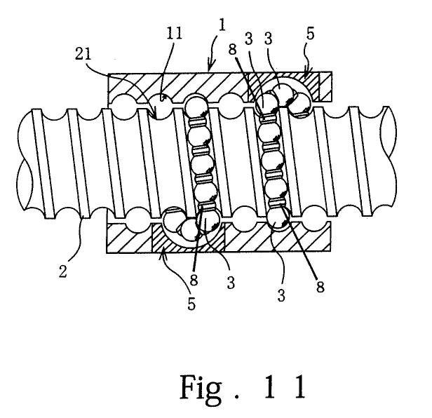

A modification of the embodiment to fix the deflector 5 to the nut 1 will be described with reference to FIG. 10. Since constitution of a ball screw device of this modification is the same with the aforementioned embodiment except the elastic members 6 and a nut housing 7 are used, only differences will be described. The elastic member 6 such as leaf spring or conical spring is previously attached on a top surface 555 of each guide member 55. After the guide members 55 are attached to the deflector pieces 51, the nut 1 is inserted (fitted) into the nut housing 7 that is a cylindrical-shape. Since the elastic members 6 contact with an inner surface of the nut housing 7, each guide member 55 and each deflector piece 51 are pushed toward the center of the nut 1. Therefore, the deflector pieces 51 and the guide members 55 are fixed to the nut 1 by elastic force of the elastic members 6. It is possible that the top portion 555 of the guide member 51 is formed as hemisphere-shaped or projection-shaped instead of attaching the leaf spring or conical spring. According to the aforementioned modification, even if the deflector 5 is two pieces, assembling process of the ball screw device does not become complicated.

Obviously, numerous modifications and variations of the present invention are possible in light of the above teachings. It is thereby to be understood that within the scope of the appended claims, the present invention may be practiced otherwise than as specifically described herein.

What is claimed is:

1. A manufacturing method of a ball screw device which comprises a nut, a screw shaft, a plural number of balls, and a deflector which comprises a deflector piece and a guide member, the manufacturing method comprising:
attaching the deflector piece to the nut;
grinding an inner surface of the nut together with an inner surface of the deflector piece;
attaching the guide member to the nut; and
assembling the balls and the screw shaft to the nut.

2. A manufacturing method of a ball screw device which comprises a nut, a screw shaft, a plural number of balls, and a deflector which comprises a deflector piece and a guide member, the manufacturing method comprising:
attaching the deflector piece to the nut;
grinding an inner surface of the nut together with an inner surface of the deflector piece;
detaching the deflector piece from the nut;
assembling the balls and the screw shaft to the nut; and
attaching the deflector piece and the guide member to the nut.
